(19) United States
(12) Patent Application Publication
(10) Pub. No.: US 2002/0138369 A1
(43) Pub. Date: Sep. 26, 2002

(54) Electronic storage medium and purchasing system and method

(76) Inventors: Douglas D. Calaway, St. Cloud, FL (US); Jason R. Kotte, St. Cloud, FL (US); Wynn Miller, St. Cloud, FL (US)

Correspondence Address: JOHN L. DEANGELIS JR. ESQ., HOLLAND & KNIGHT LLP, 1499 S. HARBOR CITY BLVD., SUITE 201, MELBOURNE, FL, 32901, US

(21) Appl. No.: 09/814,441

(22) Filed: Mar. 22, 2001

(51) Int. Cl. G06F 17/60

(52) U.S. Cl. 705/27

(57) ABSTRACT

Electronically initiating a purchase of an item using a computer includes establishing a communication between a processor and a removable electronic storage medium. The storage medium has at least one image of at least one item stored thereon. An image of an item is accessed from the storage medium and the accessed item image is viewed on a display in communication with the processor. If desired, the user electronically selects the item for purchase. An item selection automatically causes purchase data on the item to be displayed in a “shopping cart” and stored on a writable memory device in communication with the processor. Order information may be stored for subsequent recall and submission to the vendor.

### BACKGROUND OF THE INVENTION

1. Field of the Invention

The present invention relates to systems and methods for viewing and selecting images from a storage medium, and, more particularly, to such systems and methods for purchasing products depicted on a storage medium.

2. Description of Related Art

Electronic shopping has become an increasingly important segment of the marketplace. However, consumers often become discouraged by the speed of downloading and viewing images from the internet. Further, the safety of transmitting credit card information over the internet is also questionable in the minds of many consumers.

Another area of commerce that is increasing in importance is in electronic storage media, such as compact disk-read-only memory (CD-ROM) units, which can hold files of multimedia presentations. Electronic “trading cards,” for example, are known in the art, which have pictures and/or moving images based on such people as sports figures.

### SUMMARY OF THE INVENTION

It is therefore an object of the present invention to provide a system and method for viewing an image stored on an electronic medium and for initiating a purchase based upon the viewed image.

It is a further object to provide such a system and method for storing data on the purchase in electronic form prior to completing a purchase.

It is another object to provide such a system and method that permits a completing of the purchase.

It is an additional object to provide such a system and method that permits the viewing of images related to subject of the electronic medium.

These and other objects are achieved by the present invention, one aspect of which comprises a method for electronically initiating a purchase of an item using a computer. The method comprises the steps of establishing a communication between a processor and a removable electronic storage medium. The storage medium has at least one image of at least one item stored thereon.

The next steps comprise accessing an image of an item from the storage medium and viewing the accessed item image on a display in communication with the processor. If desired, the user electronically selects the item for purchase. An item selection automatically causes purchase data on the item to be stored on a writable memory device in communication with the processor.

The software application of the present invention in a preferred embodiment is resident on a storage medium that also contains digital representations of a plurality of visual images. The software application comprises means for running on a processor and means for displaying a menu on a display device in communication with the processor. The menu comprises identifiers of at least some of the images on the storage medium.

The software application also comprises means for receiving a selection of an identifier by a user through an input device in electronic communication with the processor and means for writing a file on a storage device that is in electronic communication with the processor. The written file comprises the selected identifier.

The storage medium of the present invention comprises a plurality of visual images stored in digital form thereon and the software application as described above.

The system of the present invention is for use by a consumer for electronically initiating a purchase of an item using a computer. The system comprises a removable a electronic storage medium as described above, a processor and a storage device, means for reading data from the storage medium, an input device, and a display device, all in electronic communication with the processor.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1A is a flow chart of a method of use of the system.

FIG. 1B is a schematic diagram of the system of the invention.

FIGS. 2A, 2B is a flow chart of the software of the invention.

FIG. 3 is an illustration of an exemplary menu screen.

FIG. 4 is an illustration of an exemplary tour screen.

FIG. 5 is an illustration of another exemplary tour screen.

FIG. 6 is an illustration of an exemplary image selection screen.

FIG. 7 is an illustration of another exemplary image selection screen.

FIG. 8 is an illustration of an exemplary gift selection screen.

FIG. 9 is an illustration of an exemplary checkout screen.

### DETAILED DESCRIPTION OF THE PREFERRED EMBODIMENTS

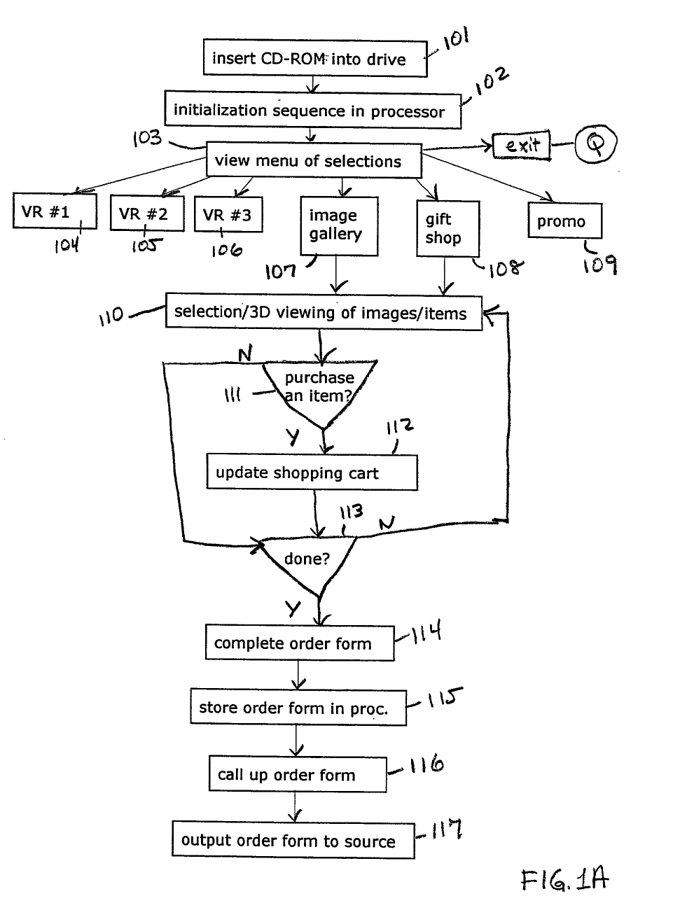

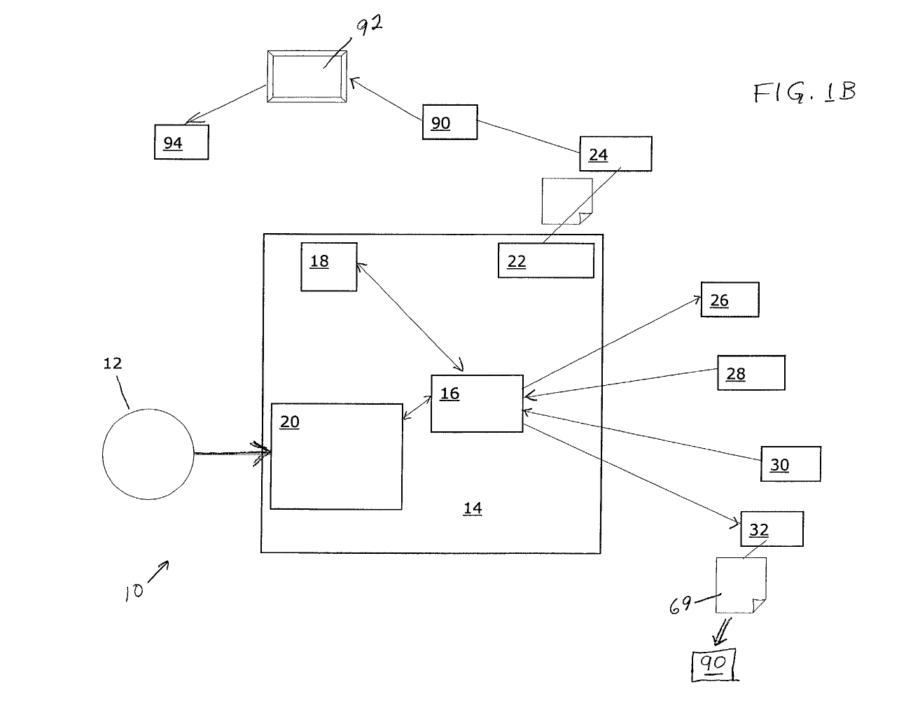

A description of the preferred embodiments of the present invention will now be presented with reference to FIGS. 1A-9.

The method of using the present invention is illustrated in FIG. 1A, and the system in FIG. 1B. The system 10 (FIG. 1B) comprises a storage medium, such as, but not intended to be limited to, a CD-ROM 12, which has stored thereon a plurality of digital representations of images and a software application. The images may comprise, but are not intended to be limited to, a two-dimensional picture, a three-dimensional image of an object, a virtual-reality walkthrough of a site, a promotion, and an item for sale, preferably related to the subject of at least one of the picture, image, or walkthrough. The software application, which will be discussed further in the following, enables the method of electronically initiating a purchase of an item from among the stored images.

The system 10 in a preferred embodiment further comprises a computer 14, which in turn comprises a processor 16 and a storage device, such as a hard drive 18, a storage medium drive, such as a CD-ROM drive 20, and a modem 22, all in electronic communication with the processor 16. The system 10 has means through the modem 22 of connecting to a network, such as the Internet 24. Peripherals in communication with the processor 16 comprise a display device such as a screen 26, a keyboard 28, a pointing device such as a mouse 30, and a printer 32. It is to be understood that this configuration is not intended to be limiting, and the alternate forms may be contemplated by one of skill in the art.

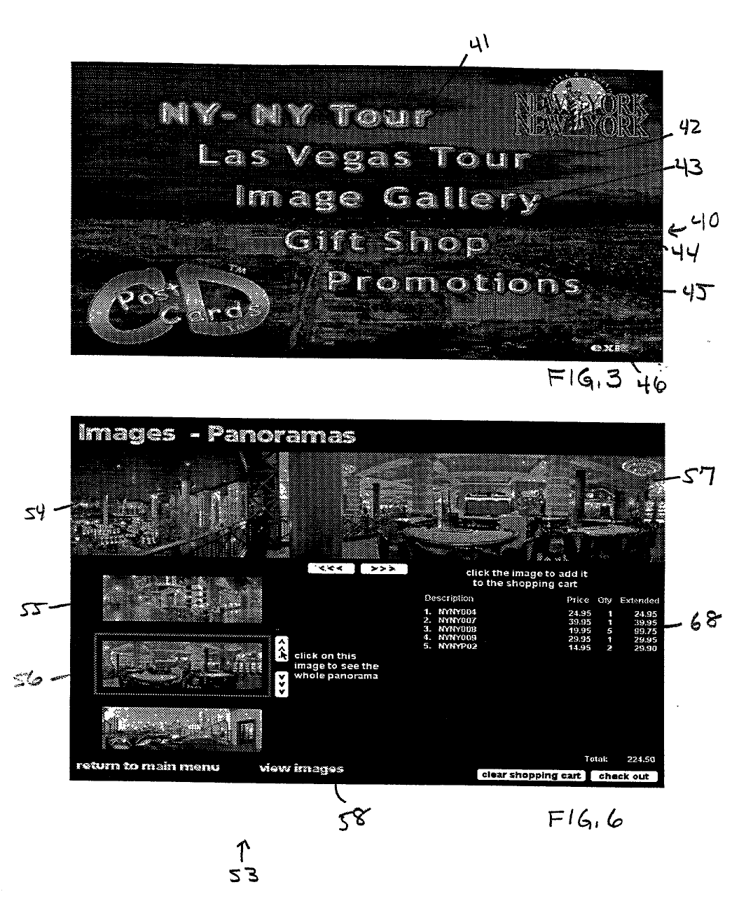

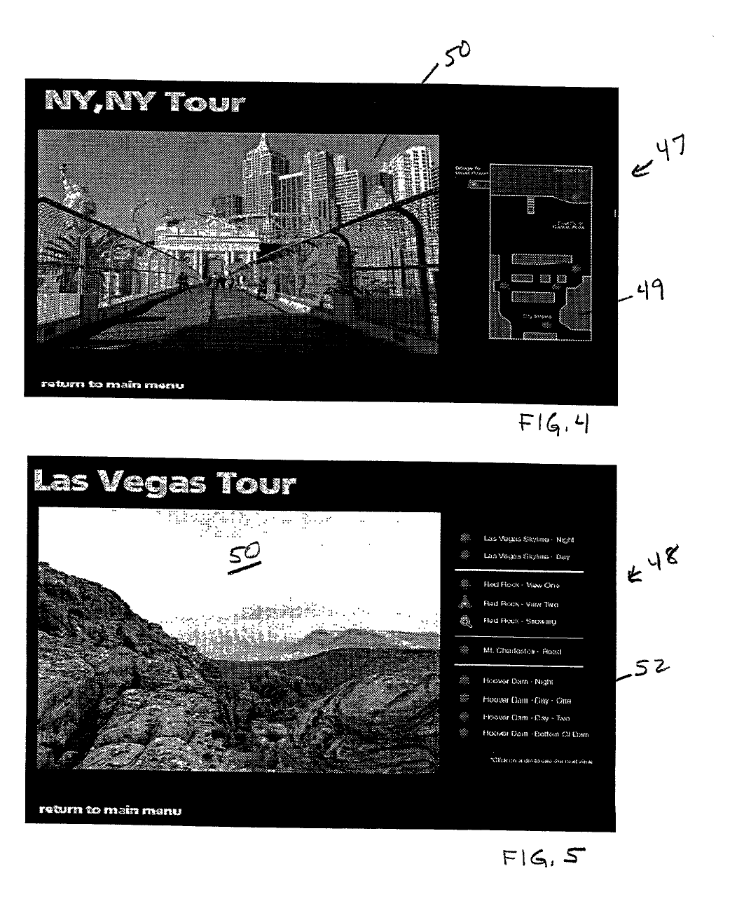

The method (FIG. 1A) of electronically initiating a purchase of an item 92 using a computer comprises the steps of the user's 94 inserting the storage medium, a CD-ROM 12 in an exemplary embodiment, into a disk drive 20 in electronic communication with a processor 12 (step 101). The processor 16 accesses the CD-ROM 12, which starts an initialization sequence carried out by the processor 12 under direction of the software on the CD-ROM 12 (step 102). A menu screen (FIG. 3) 40 appears, having a plurality of selections 41-46 from which to choose (step 103). Any number of selections may be offered, with three (steps 104-106) shown in FIG. 1A, and those illustrated on FIG. 3 are not intended to be limiting. These include virtual-reality (VR) tours of New York 41 and Las Vegas 42, which would bring up, respectively, screens 47, 48 (FIGS. 4, 5). These screens 47, 48 illustrate two possible “tours” available to the user 94: a simulated walking tour through an area as laid out in a map 49, showing where the user is in the scene 50; and a first image 51 with a list 52 of other images available for viewing.

If the “promotions” item 45 is selected, a commercial or other promotion is presented (step 109). This screen may comprise information, for example, related to the subject of the CD-ROM 12, such as addresses of chambers of commerce, dates of events such as concerts or release dates of a movie or music CD, addresses of shops, or electronic links to related internet sites.

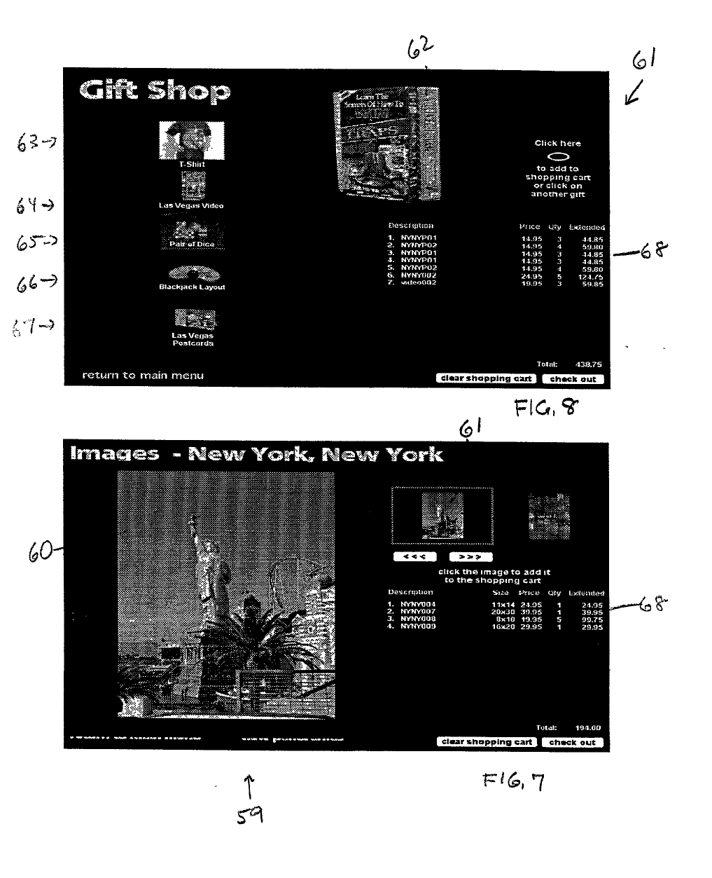

Selecting the “image gallery” choice 43 from the menu screen 40 (step 107) brings up a screen 53 (FIG. 6; step 110) with a plurality of two-dimensional images 54-57 thereon from which may be chosen one or more for purchase by selecting them on the screen with the pointing device 30. Each image has associated therewith electronic identifier data. Alternatively, a second image screen 59 (FIG. 7) is available by selecting button 58 to view a larger version 60 of an image, or the set may be scrolled through 61. The “shopping” process will be discussed further in the following.

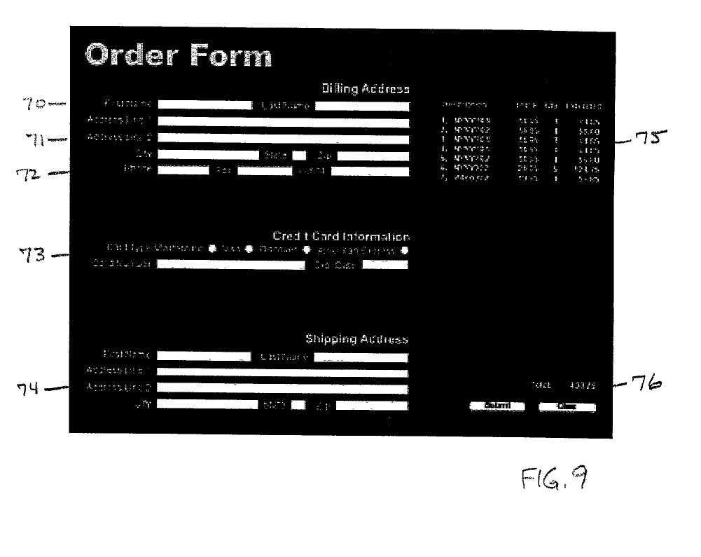

If the “gift shop” option 44 is selected from the menu screen 40 (step 108), screen 61 appears (FIG. 8; step 110) with a plurality of items 62-67 shown for sale, each having electronic identifier data associated therewith. Some or all of the items 62-67 may be stored in three-dimensional format for viewing at different angles, facilitating the selection of, for example, a statue or clothing that is better viewed in different aspects.

The “shopping” steps are substantially the same for purchasing items from any of the image gallery 52, 59 or gift shop 61 screens. If the user 94 wishes to purchase an item (step 111), he/she selects one of the items from the screen with the pointing device 30, and a “shopping cart” area 68 is updated by the software (step 112). When the shopping is complete (step 113), the order form 69 (FIG. 9) is brought up, which the user 94 completes (step 114) with the customary ordering information such as name 70, address 71, contact data 72, payment information 73, and shipping address 74. The form also lists the selected items 75 and a total cost 76 and updates quantities if desired.

At this point, if the user does not wish to place an order immediately, the system 10 stores the order form 69 data on the user's computer 14 (step 115), where it may reside until the user 94 calls it up (step 116) for processing by outputting the order form 69 data the vendor 90, who will then ship the selected item(s) 92 to the user 94. The order form may be output in any of a number of media; for example, the screen 69 itself may be used by the user 94 to place a telephone call to the vendor 90 and place an order; the screen 69 may be printed on the printer 32 and mailed or faxed to the vendor 90; or the order data may be transmitted over the Internet 24 to the vendor 90.

It can be seen that the viewing, selecting, and purchasing steps are much faster than previously known methods, and that no simultaneous connection to the Internet is required while shopping. Further, a reminder function can be provided to prompt the user 94 that a pending order remains in the computer 14 that has not been sent upon startup if desired.

Other than tours of places and associated images and items for sale, one of skill in the art will recognize that any merchandising may be accomplished with the present invention. For example, a “trading card” in the form of a CD-ROM could be offered having images, video clips, and merchandise related to a public personality such as a sports figure, an actor or performer, or an event such as a movie, television show, or concert. Alternatively, a merchandise catalog could be offered in this form, having search capabilities and much faster viewing of images than currently available online. Therefore, it is not intended that the present invention be limited to the types of visual renderings shown herein.

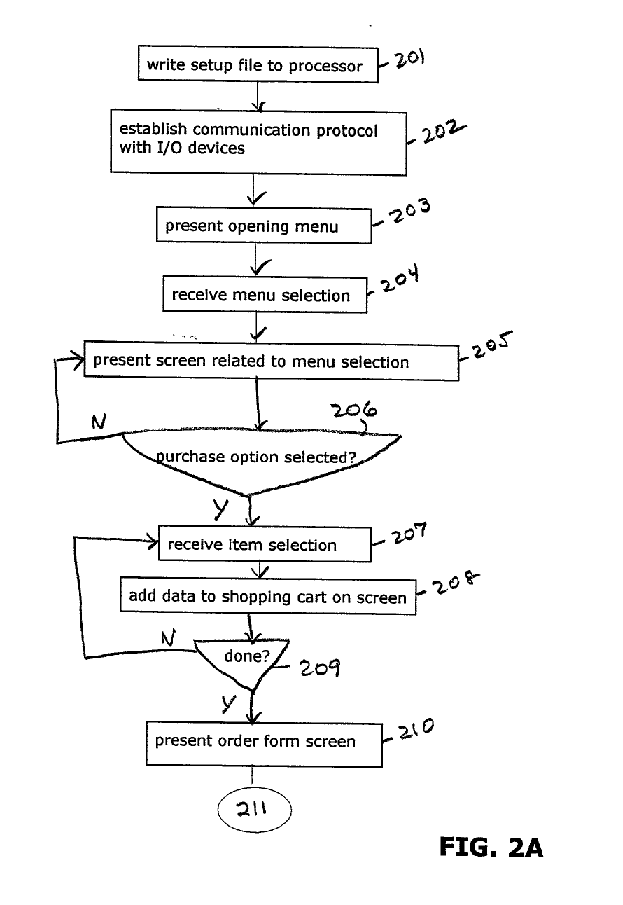

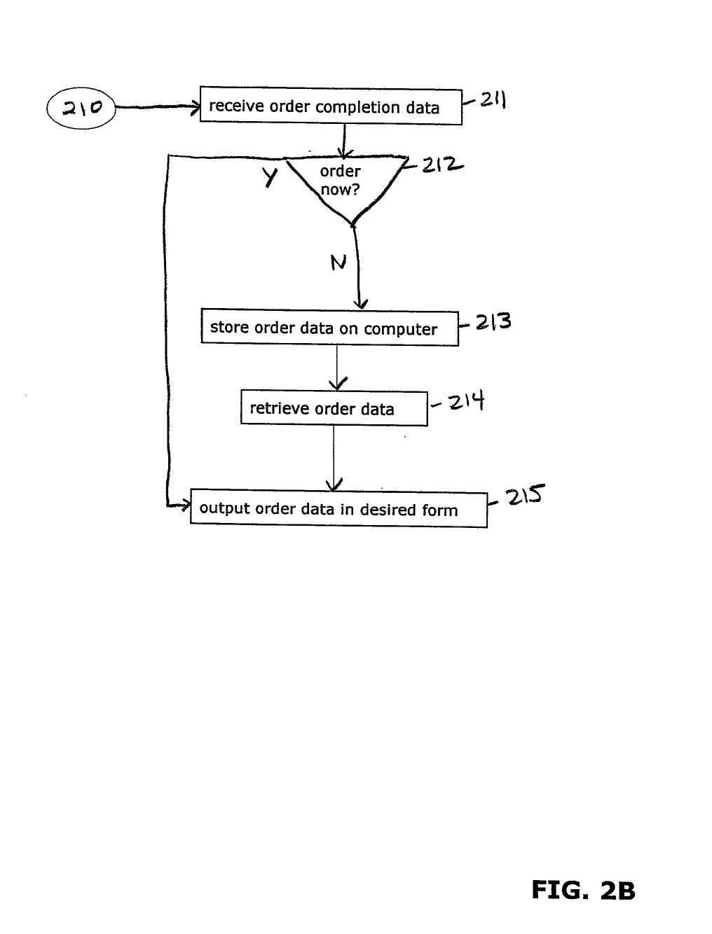

The operation of the software that drives the above-described method of the present invention is illustrated in FIGS. 2A, 2B. Once the CD-ROM is accessed, a setup file is written to the processor 16 for storage (step 201), and a communication protocol is established between the processor 16 and the I/O devices 22, 24, 26, 28, 30, 32 (step 202). The opening menu 40 is presented for viewing on the display 26 (step 203), and a selection from the user 94 is received (step 204). The screen related to the menu 40 selection is presented on the display 26 (step 205). If a purchase option is selected from the screen by, for example, clicking on an item with the mouse 30 (step 206), the selection is received (step 207), and the appropriate data are added to the shopping cart 68 on the current screen (step 208). The data may be edited as needed on screen, such as clearing the shopping cart or changing quantities, which is received and updated by the software.

Once the user 94 is done (step 209), the order form screen 69 is presented (step 210). If immediate ordering is not desired (step 212), the order data are stored on the computer 14 (step 213) for subsequent retrieval (step 214) by the user 94. As mentioned above, when ordering is desired, the form may be output in a desired form (step 215).

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the system illustrated and described herein are by way of example, and the scope of the invention is not limited to the exact details of construction.

Having now described the invention, the construction, the operation and use of preferred embodiments thereof, and the advantageous new and useful results obtained thereby, the new and useful constructions, and reasonable equivalents thereof obvious to those skilled in the art, are set forth in the appended claims.

What is claimed is:

1. A method for electronically initiating a purchase of an item using a computer, the method comprising the steps of:
establishing a communication between a processor and a removable electronic storage medium having at least one image of at least one item stored thereon;
accessing an image of an item from the storage medium;
viewing the accessed item image on a display in communication with the processor;
if desired, electronically selecting the item for purchase, an item selection automatically causing purchase data on the item to be stored on a writable memory device in communication with the processor.

2. The method recited in claim 1, wherein:
at least one image comprises a three-dimensional image; and
the viewing step comprises rotating the image in at least one dimension from a first aspect to a second aspect.

3. The method recited in claim 1, wherein the at least one image comprises two sets of images, a first set comprising an image of an object and a second set comprising an image of a saleable item related to the object.

4. The method recited in claim 1, wherein the storage medium is selected from a group consisting of a read-only memory disk and a read-write disk.

5. The method recited in claim 1, wherein the item image further comprises an electronic switch means activatable with an input device in communication with the processor for enabling the selection step.

6. The method recited in claim 5, wherein:
the electronic switch means comprises a defined region on the display; and
the electronic selection step comprises using input means for pointing at and selecting the button.

7. The method recited in claim 1, further comprising the steps of:
following the electronic selection step, accessing the writable memory device;
viewing the purchase data; and
outputting the purchase data to a vendor to complete the purchase.

8. The method recited in claim 7, wherein the purchase data outputting step comprises submitting the purchase data to the vendor in at least one of an electronic form, a hard-copy form, or via a personal communication device.

9. The method recited in claim 1, further comprising the step, following the electronic selection step, of viewing the purchase data formatted as an order form.

10. The method recited in claim 9, further comprising the step, following the purchase data viewing step, of revising an item of the purchase data to update the purchase data.

11. The method recited in claim 1, further comprising the step, following the communication establishing step, of offering a plurality of choices of material for display, including a virtual-reality tour of a site, a set of still images, and promotional information.

12. A method for assisting a buyer to make a purchase from items having images thereof stored on an electronic storage medium, the method comprising the steps of:
providing a software application on the storage medium, the software adapted to:
run on a computer comprising a processor and a storage device, an input device, and a display device in electronic communication with the processor;
display a menu on the display device comprising identifiers of the images;
receive a selection by a user through the input device of an identifier; and
write a file on the storage device comprising the selected identifier; and
interfacing the storage medium with the processor.

13. The method recited in claim 12, wherein the software is further adapted to retrieve the identifier from the storage device and display the identifier on the display device.

14. The method recited in claim 12, further comprising the step of accessing the storage medium through the processor and initializing the software application.

15. A system for electronically initiating a purchase of an item using a computer, the system comprising:
a removable electronic storage medium having at least one image of at least one item and a software application stored thereon;
a processor;
a storage device, means for reading data from the storage medium, an input device, and a display device, all in electronic communication with the processor;
wherein the software application is adapted to:
run on the processor;
display a menu on the display device comprising identifiers of the images;
receive a selection of an identifier by a user through the input device; and
write a file on the storage device comprising the selected identifier;
access an image of an item from the storage medium;
display the accessed item image on the display device;
receive a user selection of the item for purchase; and
automatically store purchase data on the item on a writable memory device in communication with the processor.

16. The system recited in claim 15, further comprising means for establishing communication between the processor and an external network, the network having means for accessing a vendor of the item.

17. The system recited in claim 16, wherein the software application further is adapted to transfer the purchase data to the vendor via the network.

18. The system recited in claim 15, further comprising means for outputting a hard copy of the purchase data.

19. A software application resident on a storage medium also containing digital representations of a plurality of visual images and purchasing data for items associated with at least some of the images, the software application comprising:
means for interfacing with a processor;
means for displaying visual images of at least some of the items on a display device in communication with the processor;
means for receiving a selection of an item from a user through an input device in electronic communication with the processor; and
means for writing a file on a storage device in electronic communication with the processor comprising the selected item and associated purchasing data.

20. The software application recited in claim 19, further comprising means for displaying a shopping cart comprising an item identifier and purchasing data associated therewith along with the visual images.

21. The software application recited in claim 20, further comprising means for displaying on the display device a complete order form comprising contents of the shopping cart.

22. The software application recited in claim 21, further comprising means for outputting the order form in at least one of an electronic form or a hard-copy form.

23. The software application recited in claim 19, further comprising means for displaying a menu of subsets of visual images and means for receiving a user selection of a subset from the input device, the user selection directing a display of the subset of images.

24. The software application recited in claim 19, further comprising means for transferring a second software application to the storage device for permitting a subsequent access of the file from the storage device without the storage medium and the processor being in communication.

25. The software application recited in claim 19, wherein the visual image displaying means further comprises means for displaying at least one image in

26. A storage medium comprising:
a plurality of visual images stored in digital form thereon and purchase data associated with at least some of the images; and
a software application comprising:
means for running on a processor;
means for displaying a menu on a display device in communication with the processor comprising identifiers of at least some of the images on the storage medium;
means for receiving a selection of an identifier by a user through an input device in electronic communication with the processor; and
means for writing a file on a storage device in electronic communication with the processor comprising the selected identifier.
